(19) United States
(12) Patent Application Publication
(10) Pub. No.: US 2008/0217452 A1
(43) Pub. Date: Sep. 11, 2008

(54) Jaw Crusher

(75) Inventor: Paul Douglas, Derbyshire (DE)

Correspondence Address: KIRTON AND MCCONKIE, 60 EAST SOUTH TEMPLE,, SUITE 1800, SALT LAKE CITY, UT, 84111, US

(73) Assignee: Extec Screens and Crushers Limited, Derbyshire (DE)

(21) Appl. No.: 10/550,035

(22) PCT Filed: Mar. 18, 2004
(86) PCT No.: PCT/GB04/01183

§ 371 Date: Feb. 7, 2008

(30) Foreign Application Priority Data
Mar. 21, 2003 (GB) 0306492.0

(51) Int. Cl. B02C 7/00

(52) U.S. Cl. 241/259.1

(57) ABSTRACT

A jaw crusher having two jaws which define an upwardly open crushing chamber for receiving crushable material and a discharge opening between the lower ends of the jaws for discharging crushed material, the jaws being relatively movable so as to vary the size of the receiving chamber and thereby exert working and relieving actions on the crushable material and so that crushed material can be discharged via the discharge opening, and in which: a rotatable elongate member extends throughout at least a major part of the length L of the jaws, and is located at or near to the discharge opening so as to assist the gravity discharge of crushed material through the discharge opening, and/or to exert an impact/crushing action in conjunction with the working actions of the jaws.

This invention relates to a jaw crusher having two jaws which define an upwardly open crushing chamber for receiving crushable material and a discharge opening between the lower ends of the jaws for discharging crushed material, the jaws being relatively movable so as to vary the size of the receiving chamber and thereby exert a working action on the crushable material.

Jaw crushers are used in a quarry environment to crush rocks to smaller size, and usually have a fixed jaw and a pivotally mounted movable jaw which is driven towards and away from the fixed jaw so as to carry out repeated cycles of crushing and relieving action on the material, such that crushed material is formed and then falls under gravity through the discharge opening, and which enables continuous or semi-continuous supply of fresh material to the receiving chamber of the jaw crusher.

Typically the upper end of the movable jaw is caused to oscillate to and fro by an eccentric drive mechanism so as to vary the size of the crushing chamber and a toggle linkage is coupled with a lower region of the movable jaw and can be adjusted so as to increase or decrease the size of the discharge opening, and which also applied to and fro motion to the lower end of the moveable jaw.

The jaws of a jaw crusher are usually provided with wear plates which exert the necessary crushing action on the material, and which are removably mounted so that worn wear plates can be replaced when necessary. Therefore, the wear plates define the actual limits of the crushing chamber, and in conventional jaw crushers no further components intrude into the crushing chamber. This results in the discharge of crushed material from the chamber relying entirely upon gravity action, as the jaws move relatively to and fro during an operating cycle.

However, given the non-uniform nature of rocks being supplied to the crusher, and their possible jamming interengagement with other rock material already in the chamber (partly crushed or not yet crushed), it is usually necessary to stop the operation from time to time when jamming arises, and/or to provide some form of fail-safe mechanism in the drive to the movable jaw, to avoid overloading of any driving components.

Further, if any material becomes jammed in the lower discharge opening, this also feeds back to the material above it which a) increases the load on the drive components and the linkage and b) prevents efficient crushing and subsequent discharge of crushed material from the chamber.

The invention therefore seeks, by simple mechanical means, to assist the gravity discharge of crushed material from the crushing chamber.

According to the invention there is provided a jaw crusher having two jaws which define an upwardly open crushing chamber for receiving crushable material and a discharge opening between the lower ends of the jaws for discharging crushed material, the jaws being relatively movable so as to vary the size of the receiving chamber and thereby exert working and relieving actions on the crushable material and so that crushed material can be discharged via the discharge opening, and in which:

a rotatable elongate member extends throughout at least a major part of the length of the jaws, and is located at or near to the discharge opening so as to assist the gravity discharge of crushed material through the discharge opening, and/or to exert an impact/crushing action in conjunction with the working action of the jaws.

Preferably, the elongate member extends substantially throughout the length of the jaws (the length of the jaws being measured in a direction perpendicular to the direction of relative movement of the jaws, and from front to rear of the chamber).

Conveniently, the member is rotatably mounted on one of the jaws, and preferably at or near to the lower end thereof.

In a preferred arrangement, one of the jaws is a fixed jaw, and the other jaw is mounted to be movable towards and away from the fixed jaw. The movable jaw may be coupled with an eccentric drive mechanism at or near its upper end, and which operates the movable jaw in a cycle comprising a working stroke approaching the fixed jaw and a relieving stroke moving away from the fixed jaw.

The elongate member preferably has a circular cross section, when the member will effectively be a roller, but it should be understood that other cross-sections may be suitable e.g. elliptical, provided that the engagement of the periphery of the rotating member with the crushed material assists in the gravity discharge of the material through the discharge opening.

The elongate member may be freely rotatable, and driven by the downward movement of the crushed material. Alternatively, the elongate member may be driven to rotate, to further assist the downward gravity-derived movement of the material. Also, more than one elongate member may be provided e.g. one rotatably mounted on the lower end of each jaw.

Preferably, a toggle or other mechanism is coupled with the lower end of the movable jaw, at a position below the coupling of the eccentric drive mechanism to the movable jaw, and is operative to move the lower end of the jaw to and fro so as to assist the working action of the jaw.

Preferably, the elongate member serves both to assist the gravity discharge material, but may also function as an impact or crushing roller to further assist the crushing action of the jaws, by operating in cooperation with the movement of the lower end of the movable jaw.

Alternatively, the elongate member may be arranged mainly to exert an impact or crushing action, in cooperation with the movement of the lower end of the movable jaw.

A preferred embodiment of jaw crusher according to the invention will now be described in detail, by way of example only, with reference to the accompanying drawing, in which:

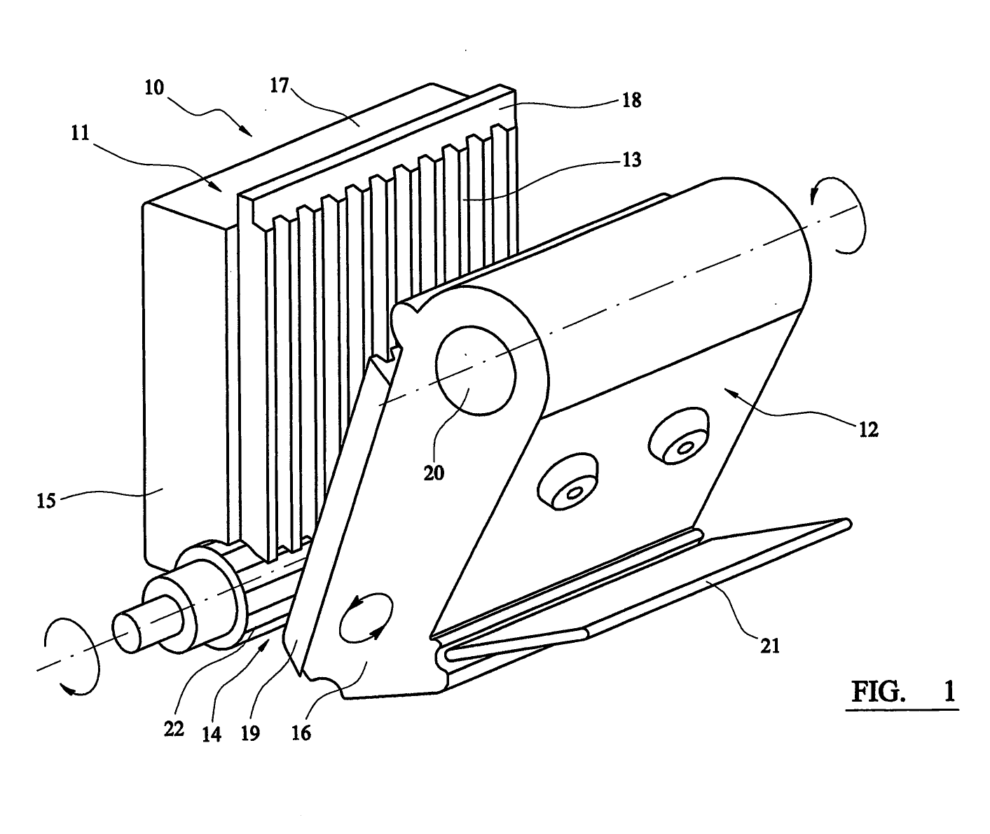

FIG. 1 is a perspective illustration of a first embodiment of jaw crusher according to the invention, having a fixed jaw and a movable jaw, and showing the jaws in an “open” configuration for receiving a supply of crushable material;

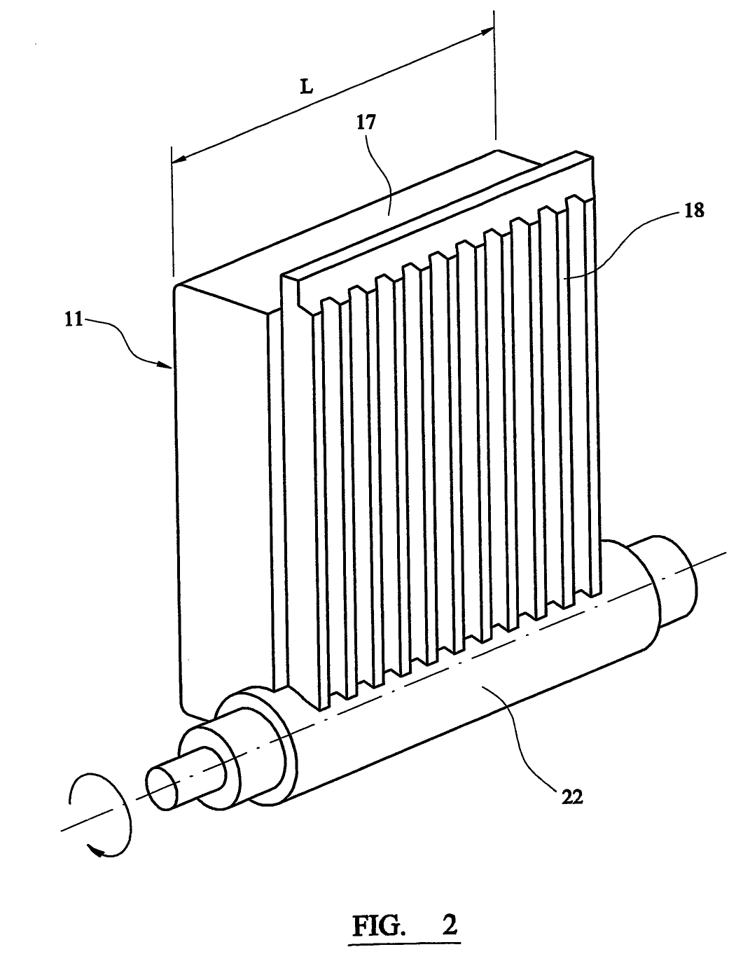

FIG. 2 is a perspective illustration from one side of the fixed jaw of the crusher shown in FIG. 1;

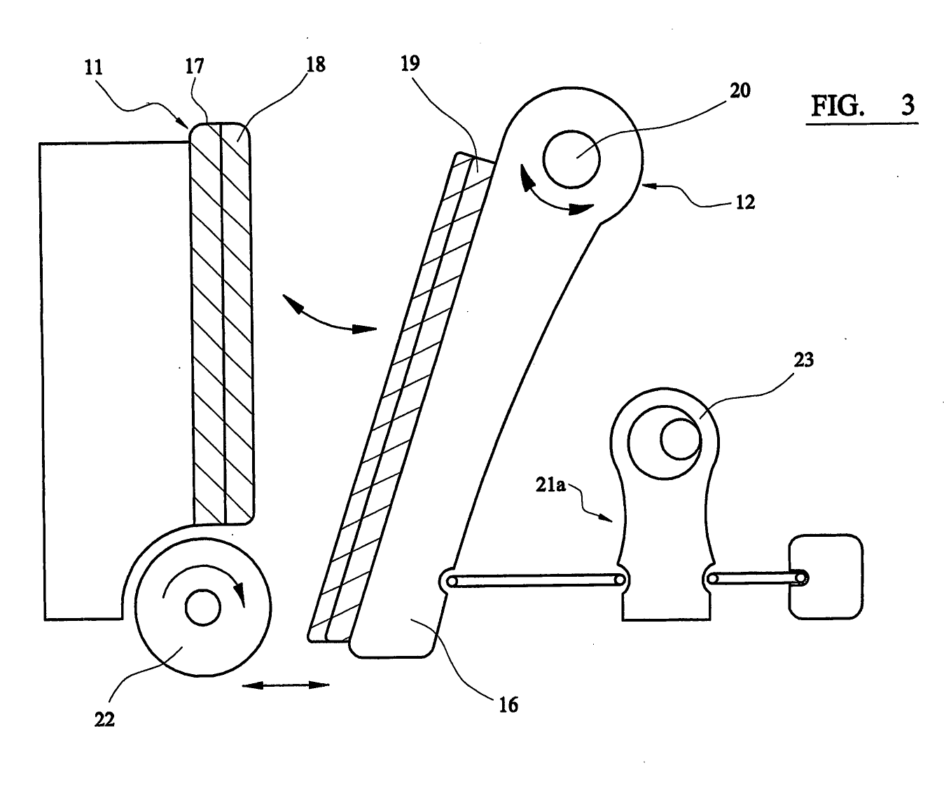

FIG. 3 is a schematic side illustration of a double toggle reciprocating drive linkage coupled to a lower end of the movable jaw of a crusher of the general type shown in FIG. 1;

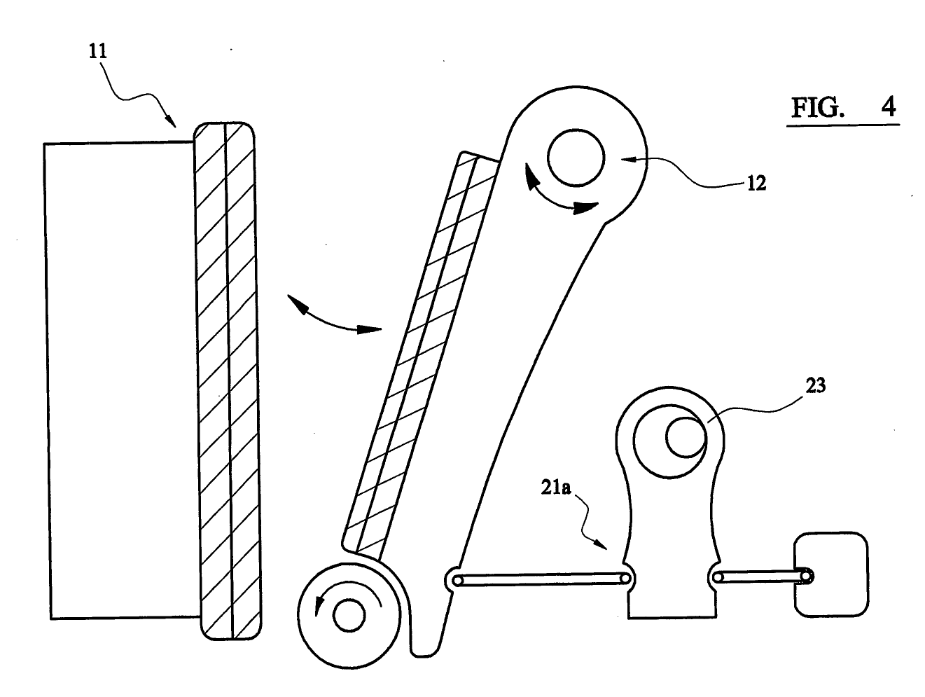

FIG. 4 is a similar view to FIG. 3, but of a second embodiment of jaw crusher according to the invention;

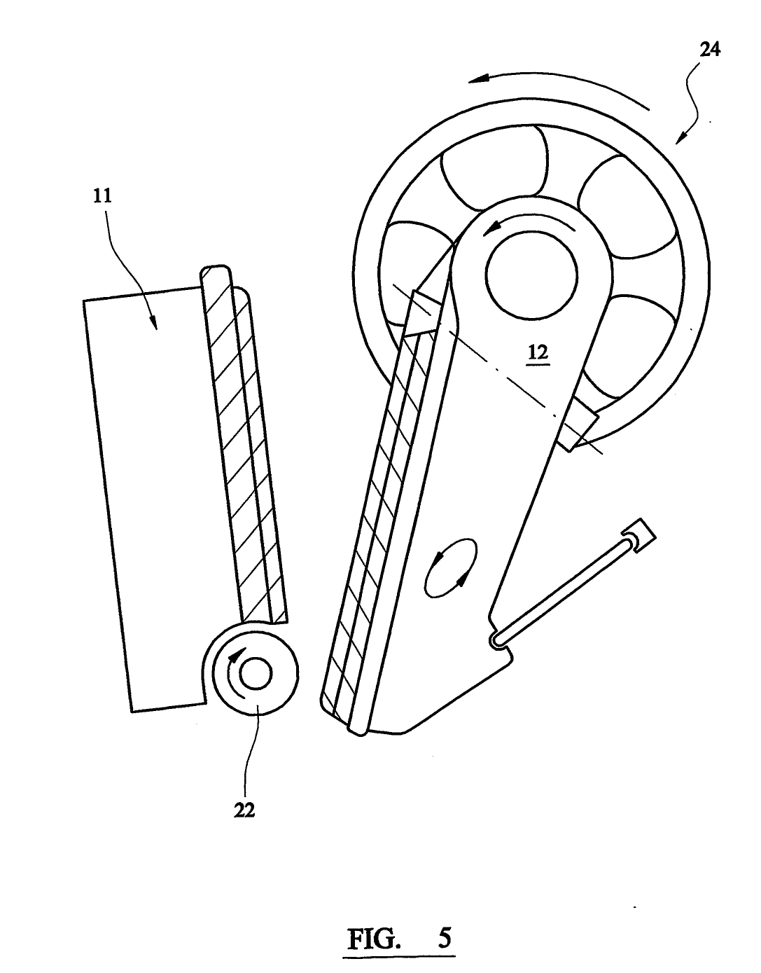

FIG. 5 is a schematic side view illustration of a fly wheel-driven drive mechanism for applying reciprocating linear motion to the upper end of the movable jaw, to carry out working and relieving strokes on the crushable material, and of the general type of jaw crusher of the first embodiment shown in FIG. 1; and

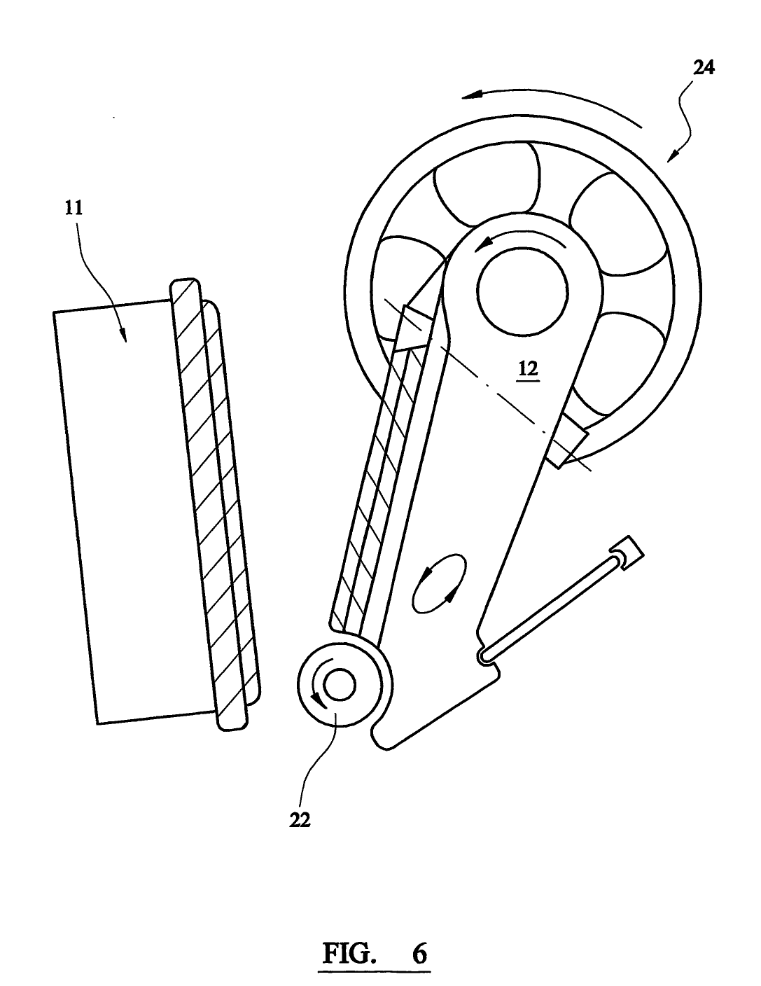

FIG. 6 is a view, similar to FIG. 5, showing the fly wheel drive arrangement coupled with the movable jaw, and applied to a jaw crusher of the type shown in the second embodiment of the invention of FIG. 4.

Referring first to FIG. 1 of the drawings, a first embodiment of jaw crusher according to the invention is illustrated, designated generally by reference 10, and having two jaws 11 and 12 which define an upwardly open crushing chamber 13 for receiving crushable material, and a discharge opening 14 between the lower ends 15 and 16 of the jaws 11 and 12 respectively, for discharging crushed material.

The jaws 11 and 12 are relatively movable so as to vary the size of the receiving chamber 13 and thereby exert working and relieving actions on the crushable material, and so that crushed material can be discharged via the discharge opening 14.

In the illustrated embodiment, the jaw 11 is a fixed jaw having a front beam 17 and a fixed jaw plate 18, and the jaw 12 is a movable jaw having a wear or jaw plate 19. An eccentric drive mechanism is coupled with the upper end of the movable jaw 12, and is shown schematically only by an eccentric drive 20. A toggle linkage is shown schematically by reference 21, and is coupled with the lower end of the jaw 12.

Also, the toggle linkage applies to and fro movement to the lower end of the movable jaw, to assist the crushing/working action.

The means of applying movement to and fro of a movable jaw of a jaw crusher are well known, and any suitable conventional arrangements may be provided. The “throw” of the eccentric drive 20 will determine the extent of the linear reciprocating movement applied to the upper end of the jaw 12, during a working cycle. Adjustment of the width of the discharge opening 14 also can be carried out by adjustment of the toggle linkage 21.

Referring to FIG. 2, this shows in more detail the construction of the fixed jaw 11, and it will be noted that a rotatable elongate member is provided, designated by reference 22, and which extends throughout at least a major part of the length L of the jaw 11, and is located at or near to the discharge opening 14 so as to assist the gravity discharge of crushed material through the opening. In the embodiment of FIG. 2, the elongate member 22 takes the form of a roller of circular cross section, and which is rotatably mounted at or near to the lower end of the fixed jaw 11. The member 22 may be freely rotatable, so as to be driven by engagement with the downwardly moving crushed material. Alternatively, a drive input (not shown) may be coupled with the member 22, to apply continuous rotation and thereby to further assist the gravity discharge of crushed material.

The preferred cross section of the member 22 is circular, so that it forms a roller, but other cross sections may be adopted e.g. elliptical, provided that they permit the periphery of the member to engage with and assist the downward movement of the crushed material.

In addition, the member 22 operates as an impact/crushing roller, which works in cooperation with the moving lower end of the movable jaw, in order to exert additional crushing action. Preferably, the member 22 therefore has a dual function of (a) assisting gravity discharge of crushed material and (b) assisting the overall crushing action exerted by the jaws.

However, in an alternative embodiment of the invention, the member 22 may be arranged to function mainly as an impact/crushing roller.

Referring now to FIG. 3 of the drawings, this shows in more detail a jaw crusher of the general type shown in the first embodiment, and corresponding parts are given the same reference numerals. In this embodiment, the elongate member/roller 22 is associated with the fixed jaw 11. FIG. 3 shows a double toggle linkage 21a, coupled with the lower end 16 of the movable jaw 12, and driven by a Pitman type drive 23.

Referring now to FIG. 4, this is a view, similar to FIG. 3, showing double toggle linkage 21a, but in this embodiment, the elongate member/roller 22 is associated with the movable jaw 12.

Referring to FIG. 5, this shows in more detail a fly wheel operated drive mechanism to apply linear reciprocating movement to the upper end of the movable jaw 12, and designated generally by reference 24. The elongate member/roller 22 is associated, in this arrangement, with the fixed jaw 11.

FIG. 6 is a view, similar to FIG. 5, but showing the fly wheel drive arrangement coupled with movable jaw 12, and in which elongate member/roller 22 is associated with the movable jaw 12.

The embodiments of the invention therefore provide one or more rotatable elongate elements which assist the discharge of crushed material via the lower discharge opening, and this therefore increases the rate of production, and provides for improved operating efficiency of the jaw crusher machines of the invention.

1. A jaw crusher having two jaws which define an upwardly open crushing chamber for receiving crushable material and a discharge opening between the lower ends of the jaws for discharging crushed material, the jaws being relatively movable so as to vary the size of the receiving chamber and thereby exert working and relieving actions on the crushable material and so that crushed material can be discharged via the discharge opening, and in which:
a rotatable elongate member extends throughout at least a major part of the length L of the jaws, and is located at or near to the discharge opening so as to assist the gravity discharge of crushed material through the discharge opening, and/or to exert an impact/crushing action in conjunction with the working actions of the jaws.

2. A jaw crusher according to claim 1, in which the elongate member extends substantially throughout the length L of the jaws.

3. A jaw crusher according to claim 1, in which the elongate member is rotatably mounted on one of the jaws.

4. A jaw crusher according to claim 3, in which the elongate member is rotatably mounted on one of the jaws, at or near to the lower end thereof.

5. A jaw crusher according to claim 1, in which one of the jaws is a fixed jaw, and the other jaw is mounted to be movable towards and away from the fixed jaw.

6. A jaw crusher according to claim 5, in which the movable jaw is coupled with an eccentric drive mechanism which operates the movable jaw in a cycle comprising a working stroke approaching the fixed jaw and a relieving stroke moving away from the fixed jaw.

7. A jaw crusher according to claim 1, in which the elongate member has a circular cross section, and comprises a roller.

8. A jaw crusher according to claim 1, in which the elongate member is freely rotatable, and arranged to be driven by the downward movement of the crushed material.

9. A jaw crusher according to claim 1, in which the elongate member is arranged to be driven to rotate, to further assist the downward gravity-derived movement of the material.

10. A jaw crusher according to claim 1, having more than one elongate member arranged at or near to the discharge opening, so as to assist the gravity discharge of crushed material through the discharge opening.

11. A jaw crusher according to claim 1, in which a toggle or other mechanism is coupled with one of the jaws and is operative to apply to and fro movement to the lower end of the jaw, which cooperates with said elongate member to exert additional crushing action on the material.
